(19) United States
(12) Patent Application Publication
(10) Pub. No.: US 2024/0088633 A1
(43) Pub. Date: Mar. 14, 2024

(54) SPOOL AND CONDUIT STORING SYSTEM AND METHOD FOR LIFT PLATFORM

(71) Applicant: Nicholas BRYANT, Shelbyville, IN (US)

(72) Inventor: Nicholas BRYANT, Shelbyville, IN (US)

(21) Appl. No.: 18/367,209

(22) Filed: Sep. 12, 2023

Related U.S. Application Data
(60) Provisional application No. 63/405,990, filed on Sep. 13, 2022.

(51) Int. Cl. H02G 1/08

(52) U.S. Cl. CPC H02G 1/08

(57) ABSTRACT

A conduit holding system mountable on a guard rail of a lift platform includes a a holder body, upper and lower hooks extending from the holder body that are positionable over the upper and lower guard rails and upwardly projecting arms from the holder body sufficient to allow placement of conduit between the arms.

This US non-provisional patent application claims priority to and the benefit of US non-provisional patent application Ser. No. 63/405,990 filed 13 Sep. 2022 the entire contents of which is specifically incorporated herein by reference.

### FIELD OF THE INVENTION

The present invention relates to the storage and accessibility of electrical conduit (pipe) and wire on a platform lift.

### BACKGROUND

Workers such as electricians on platform lifts need to access and use conduit and wire on spools during a job. Often, workers leave conduit and wire on the floor of the lift platform. They are prone to being accidentally kicked off the platform which is dangerous to others below the platform. Also, keeping such items on the floor requires the worker to repeatedly lean over to pick up the item. This leads to back injury, especially because the platform is small and the worker cannot always position himself in an optimal position to bend over, especially if more than one worker is on the platform or is wearing a safety harness that limits mobility. Having to reach for items from a platform floor also takes time, and there is a desire to minimize the time required for any job. Also, construction items need to be organized. For example a job can be completed more efficiently if necessary items such as conduit and wire are always located in a consistent place on the lift, and are accessible without having to bend over.

It is also desirable to provide a system that can easily be relocated between different lift platforms, or to other locations on the same lift platform, and that does not require any hardware to attach it to the platform.

### BRIEF DESCRIPTION OF THE DRAWINGS

FIG. 1 shows representative prior art lift platforms having upper and lower guard rails.

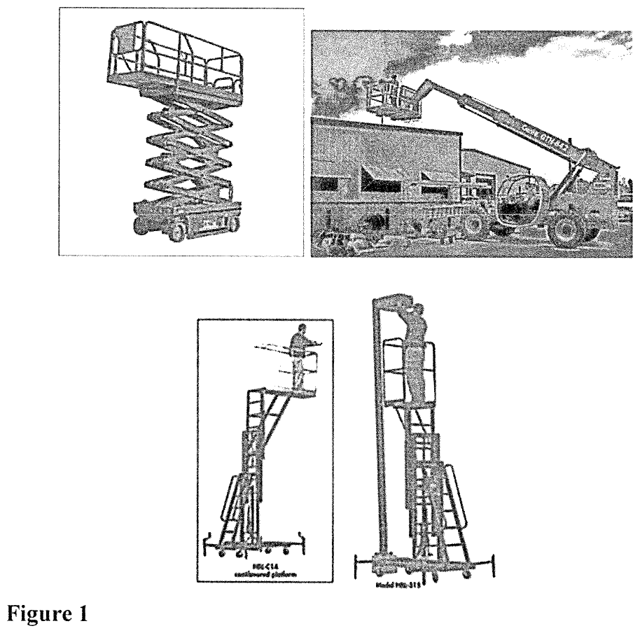

FIG. 2 is a perspective view of two spool and conduit holding systems mounted on the guard rails of a lift platform showing conduit and wire held by the systems.

FIG. 3 is a side view of a spool and conduit holding system for a lift platform.

FIG. 4 is a perspective view of a spool and conduit holding system for a lift platform.

### DETAILED DESCRIPTION

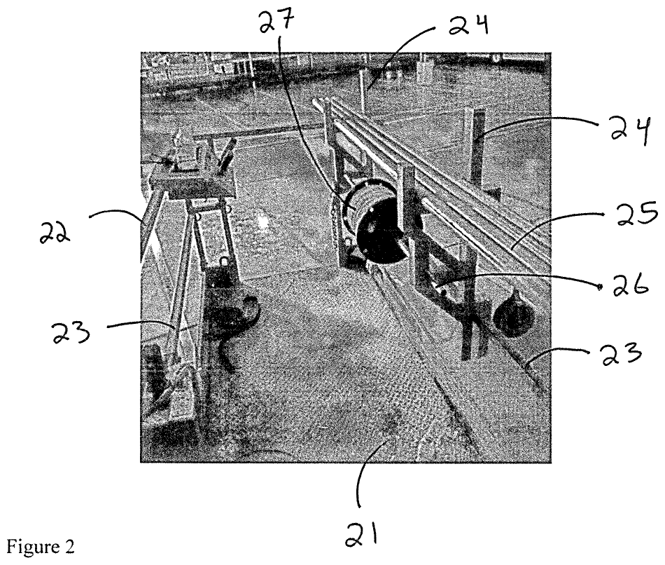

As shown in FIG. 2, lift platform 21 includes upper guard rails 22 and lower guard rails 23. Two holding systems 24 are mounted on the guard rails, and hold conduit 25 and a pipe 26 on which a spool of wire 27 is mounted. The height of pipe 26 holding the wire spools is sufficiently below the top guard rail 22 to provide an economic utilization of the space on and above the lift platform.

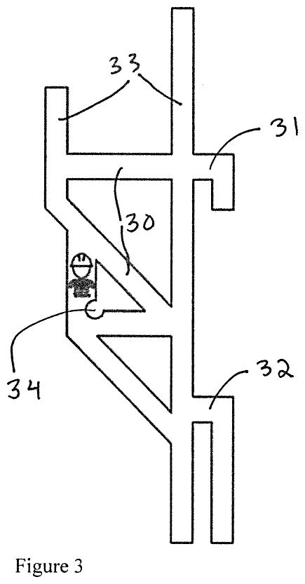

As shown in FIG. 3 each holding system includes a holder body 30, an upper hook 31 positionable over the upper guard rail of a lift platform that extends from holder body 30, and a lower hook 32 beneath upper hook 31 that is positionable over the lower guard rail of the lift platform, and which also extends from holder body 30. The system also includes two arms 33 that upwardly project arms from holder body 30 defining a space therebetween sufficient to allow placement of a plurality of conduit 25 between them.

Top hook 31 typically bears the weight of the holder and the conduit and wire mounted on it. Bottom hook 32 may bear some of the weight if the gap between with top surfaces of the upper and lower guardrails just happen to match the distance between the interior of the hooks 31, 32. However, the primary purpose of lower hook 32 is to prevent the holder from pivoting and to keep it in the position shown in FIG. 2. Thus, the depth of the upper hook 31 is less than the depth of the lower hook 32 of each conduit holder. The deeper depth of lower hook 32 allows it to fit on lift platforms of different manufacturers whose upper guard rail and lower guard rails may be different distances apart.

Holder body 30 may further include a recessed surface 34 for holding a pipe. The recessed surface has a slightly lowered position than adjacent surfaces of holder body 30 which makes it operable to limit lateral movement of a pipe 26 in recessed surface 34. The recessed surface may have a width slightly larger than the width or diameter of the pipe such that a pipe in the recessed surface does not shift or slide toward or away from the guard rail.

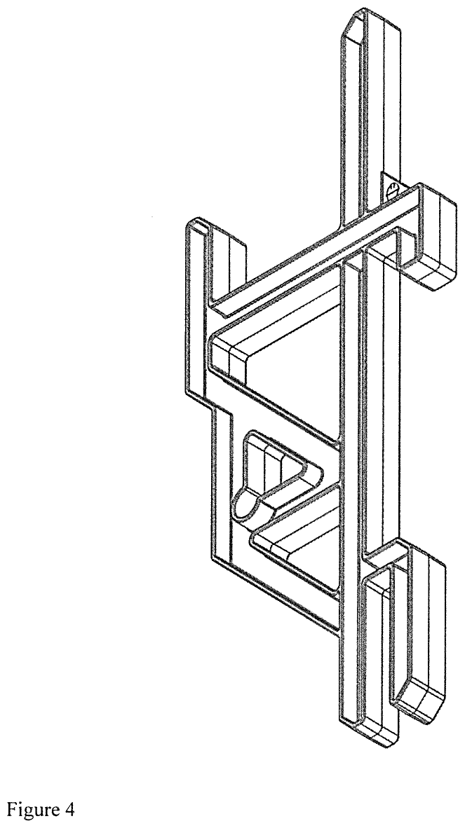

The conduit holder system may be comprised of a non-conductive material such as plastic. The conduit holder system may be made by injection molding. As shown in FIG. 4 the external surfaces of the holder may be wider than the central structure of holder body 30 to thereby minimize weight while providing sufficient structural rigidity.

Two holders may be mounted on any set of guardrails on the lift platform and at any point along the length of the guardrails, such as is shown in FIG. 2. The system makes it possible for the lift platform to hold multiple pieces of conduit and reduces the need for the platform to be lowered and raised to obtain each individual piece of conduit.

Multiple spools of wire may be held on pipe 26, and the wires may be of different types. For example, one spool may hold electrical wire, a second spool may hold security system wire, and another spool may hold telecommunications cable. The system helps keep the floor of the lift platform free of clutter and allows an electrician to reach and manipulate conduit and wire without excessive bending as compared to storing these items on the floor of the lift platform.

The holder does not require screws or other attachment devices to be secured to the lift platform, so it does not mar the finished surface of the lift platform. The holder can easily be removed from one area on a lift platform guard rail to another area on the guard rail, or from one lift platform and moved to different lift platform. These features are important because many contractors rent lift platforms, as opposed to owning them, so the contractors are not allowed to permanently attach fixtures to rented lift platforms and must return them in an unblemished condition.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A conduit holding system mountable on a guard rail of a lift platform having upper and lower guard rails comprising:
a holder body;
an upper hook positionable over the upper guard rail of a lift platform, the upper hook extending from the holder body;
a lower hook beneath the upper hook positionable over the lower guard rail of a lift platform, the lower hook extending from the holder body;
upwardly projecting arms from the holder body defining a space therebetween sufficient to allow placement of a plurality of conduit between the arms.

2. The conduit holding system of claim 1 wherein the depth of the upper hook is less than the depth of the lower hooks of each conduit holder.

3. The conduit holding system of claim 1 where in the holder body further comprises:
a recessed surface for holding a pipe operable to limit lateral movement of the pipe while in recessed surface.

4. The conduit holder system of claim 1 wherein the system is comprised of a non-conductive material.

6. The conduit holder system of claim 4 wherein the system is comprised of plastic.

7. A method for installing wire and conduit using a lift platform comprising:
providing two conduit holding system of claim and mounting them on the guard rails of a lift platform,
positioning a pipe having a spool of wire on it in the recessed surfaces of the conduit holding systems so the spool is between the two holding systems,
loading conduit so onto the holding systems between the upwardly projecting arms of each holding system,
raising the lift platform to the area where the conduit and wire are to be installed,
before lowering the lift platform, removing conduit and wire and installing them, and
lowering the lift platform.
